(19) United States
(12) Patent Application Publication
(10) Pub. No.: US 2011/0211084 A1
(43) Pub. Date: Sep. 1, 2011

(54) Method and a Device For Remotely Controlling an On-Board Camera in a Mobile Station

(75) Inventor: Marc Sturzel, Montrouge (FR)

(73) Assignees: European Aeronautic Defense andSpace Co.; EADS France

(21) Appl. No.: 13/058,837

(22) PCT Filed: Aug. 18, 2009
(86) PCT No.: PCT/EP09/60650

§ 371 Date: May 9, 2011

(30) Foreign Application Priority Data
Aug. 20, 2008 (FR) 0855644

(51) Int. Cl. H04N 5/232

(52) U.S. Cl. 348/211.99; 348/E05.042

(57) ABSTRACT

The invention is in the field of remote control of a device on board a mobile vehicle and concerns more specifically a method and a device for controlling, from a remote station, a camera on board a mobile station.

According to the invention,
the remote station estimates the period of latency L between the despatch of a command from the mobile station and the execution of the said command by the said mobile station,
the mobile station transmits to the remote station a first image acquired by the said camera at an instant T-L,
the remote station transmits to the mobile station a position of the target object in the said first image,
the mobile station compares the position of the target object in the first image with the position of the said object in at least a second image acquired after the said first image, and determines in real time, independently, the trajectory of a target object in the said second image, and then controls the on-board camera in real time to accomplish the tracking of the target object in the predicted trajectory.

### TECHNICAL FIELD

The invention is in the field of remote control of a device on board a mobile vehicle, and concerns more specifically a method and a device for controlling, from a remote station, a camera on board a mobile station transmitting to the said remote station images including at least one target object to be located in a zone explored by the said camera.

The invention also concerns a computer program recorded on a recording medium and able, when executed on a computer, to implement the method according to the invention.

### STATE OF THE PRIOR ART

Remote control of a mobile camera by a control device located in a remote station is implemented by an exchange of signals between the controlling device and the camera using communication techniques and protocols appropriate for the distance, the speed of movement of the camera and the transmission conditions.

When the camera is on board a drone, for example, and the exchanged signals transit over a slow channel, for example via a satellite, a phenomenon of latency occurs due to the transmission time of the control signals of the remote station to the drone over the slow channel, and to the transmission time of the camera images to the remote station. Thus, when an operator, located in the remote station, designates a target object on the image displayed on this remote station, and transmits a command to the camera instructing it to track the designated object, the command reaches the camera after a period of latency, during which the object designated by the operator in the image at an instant T no longer has the same position in the image seen in the drone at the time when the command is received. More specifically, if the latency is L seconds, the image displayed on the ground station at instant T is the one acquired on board at instant T-L, and the command given from the station at instant T will be received on board at instant T+L.

If the operator sends a second command to the camera before it has interpreted the previous command, a pumping phenomenon occurs, the consequence of which is that the operator loses control of the camera in that they are unaware of the impact of the commands sent during the period of latency.

One aim of the invention is to compensate for the disadvantages of the prior art described above.

### Account of the Invention

These aims are achieved by means of a method for controlling, from a remote station, a camera on board a mobile station transmitting to the said remote station images including at least one target object to be located in a zone explored by the said camera.

The method according to the invention includes the following steps:
the remote station estimates the period of latency L between the despatch of a command from the mobile station and the execution of the said command by the said mobile station,
the mobile station transmits to the remote station a first image acquired by the said camera at an instant T-L,
the remote station transmits to the mobile station a position of the target object in the said first image,
the mobile station compares the position of the target object in the first image with the position of the said object in at least a second image acquired after the said first image,
if the compared positions are identical in the two images realigned in relation to one other the mobile station transmits the said position to the remote station for validation,
otherwise, the mobile station determines, in real time, independently, the trajectory of the target object in the said second image, and then controls the on-board camera in real time in order to accomplish the tracking of the target object over the predicted trajectory.

The trajectory of the target object in the second image is preferably determined by a predictive computation according to the position and movement vector of the target object at instant T-L.

In a first embodiment the method according to the invention also includes the following steps:

in the remote station:
realigning the first image and the second image,
determine the position and speed vector of all the objects moving in the scene observed by the camera,
determining the position and speed vector of the target object in the first image, either among the moving objects, or among the background elements,
calculating a prediction of the position and speed of the target object at instant T+L,
transmiting the designated position, the predicted position and the predicted speed vector from the remote station to the mobile station.

By means of the method according to the invention the mobile station can determine the position of the target object in the second image, acquired at instant T+L, realigned in relation to the first image, acquired at instant T-L, according to the predicted position and the predicted speed vector, without an additional command to move the camera from the remote station.

In a variant, the readjustment of the first image and of the second image is accomplished by estimating the transient homography, and latency time L is estimated by time-stamping of the data and by synchronisation of the said remote and mobile stations.

In a second embodiment the method also includes a step consisting in recording the transient homographies, image by image, and the overall position of the mobile objects from instant T-L to instant T+L in the mobile station.

In this second embodiment the prediction in the remote station is no longer required. The method is occurs as follows:
on reception, by the mobile station, at an instant T+L of a request to locate the target object designated at an instant T in a local image in the mobile station, acquired after the image transmitted to the remote station at instant T-L, the position and the speed vector sent from the remote station are equal to those calculated in the image taken at instant T-L,
they are compared with the data recorded at instant T-L on board the mobile station,
after the comparison has been made at instant T-L, the data recorded on board the mobile station enables, by application of the successive homographies, or by monitoring of the tracks of the moving objects, depending on whether the target is fixed or moving, the position and speed vector of the target object at the current instant T+L to be deduced from this data.

The target object may typically be a vehicle, an individual, a building or any type of fixed or mobile aircraft.

In the event that the target object is mobile, if its trajectory leaves the field of vision of the camera at an instant t between T-L and T+L, the position of the said target object is estimated in the mobile station by a predictive calculation on the basis of its position and its speed vector at instant t, from instant t and in each following image.

The method thus allows the camera to modify its field of vision independently in order to include in it the position predicted in this manner of the target object, without any additional command to this end. The predictive calculation is made using all the transient homographies of the successive images from instant t to instant T+L, and using the prediction in image t of the movement of the object on the basis of its movement at the time of the preceding images.

In a particular application of the method according to the invention, the camera is on board a drone.

The method according to the invention is implemented by a device for controlling, from a remote station, a camera on board a mobile station transmitting to the said remote station images including at least one target object to be located in a zone explored by the said camera.

According to the invention the said remote station includes:
means to estimate the period of latency L between the despatch of a command from the mobile station, and the execution of the said command by the said mobile station,
   and the said mobile station includes:
means to compare a position of the target object in a first image acquired by the said camera at an instant T-L with the position of the said object in at least a second image acquired after the said first image,
means for predictive calculation able to determine, in real time, the trajectory of the target object in the said second image,
means to control, in real time, the on-board camera to undertake the tracking of the target object in the predicted trajectory.

The method according to the invention is implemented by means of an application recorded on a recording medium and able, when it is executed on a computer, to control a camera on board a mobile station from a remote station, where the said mobile station transmits to the said remote station images including at least one target object to be located in a zone explored by the said camera.

This application includes:
a first executable module in the remote station including:

instructions to estimate the period of latency L between the despatch of a command from the mobile station and the execution of the said command by the said mobile station,

instructions to determine the movement from one image to another of the fixed objects and of the mobile objects in order to facilitate the designation of the target object,
a second executable module in the mobile station including:

instructions to compare a position of the target object in a first image acquired by the said camera at an instant T-L with the position of the said object in at least a second image acquired after the said first image,

instructions to determine in real time the trajectory of the target object in the said second image, and

instructions to control, in real time, the on-board camera to undertake the tracking of the target object in the predicted trajectory.

### BRIEF DESCRIPTION OF THE ILLUSTRATIONS

Other characteristics and advantages of the invention will become clear from the following description, which is given as a non-restrictive example, with reference to the appended figures, in which:

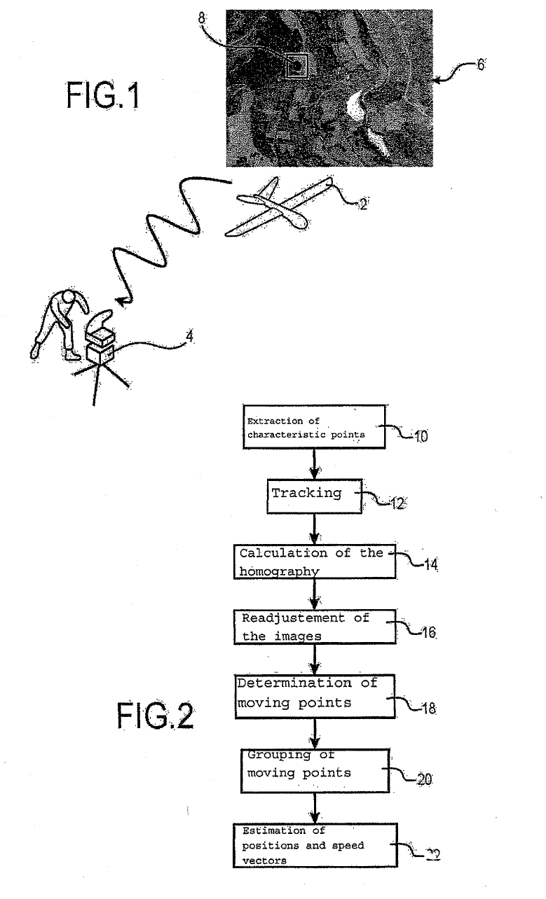

FIG. 1 illustrates diagrammatically an example embodiment of the method according to the invention

FIG. 2 is a block diagram illustrating image processing undertaken on the mobile station of FIG. 1,

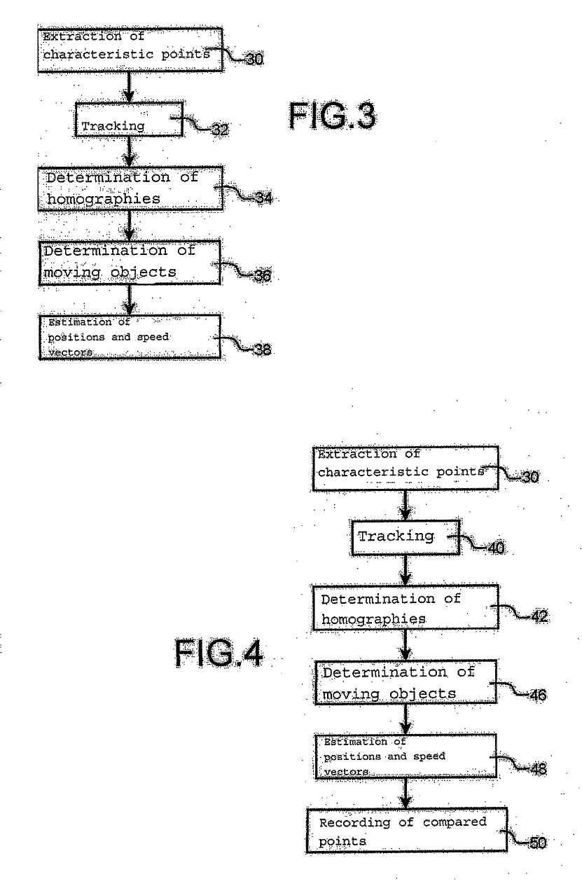

FIG. 3 illustrates the processing undertaken on a remote station of FIG. 1,

FIG. 4 illustrates diagrammatically the steps of a particular embodiment of the invention.

### DETAILED ACCOUNT OF PARTICULAR EMBODIMENTS

FIG. 1 illustrates diagrammatically mobile station 2 fitted with one or more observation cameras controlled from a remote station 4.

Mobile station 2 is a drone overflying a zone 6 in which is located a target object 8, for example a vehicle, the position of which must be known at all times by the remote station 4.

Remote station 4 is typically a drone control ground station.

The cameras on board the drone 2 continually transmit to the remote station 4 images from zone 6. In response, the remote station 4 transmits to the drone 2 signals designating the position of the target object 8 in the received images.

As illustrated by FIG. 2 the transmission channel brings about a latency time L. As a consequence, an image observed in station 4 at an instant T corresponds to an image acquired by the camera on board drone 2 at instant T-L, and all commands sent at instant T from the remote station 4 to the drone 2 will arrive in the drone at instant T+L.

As a consequence, the tracking of the target object 8 by the camera requires that designation signals sent to the drone 2 are continually updated.

The method according to the invention enables the drone to undertake this updating independently, avoiding successive transmissions of designation signals to the drone 2.

This updating is obtained by parallel processing undertaken in a distributed manner between the remote station 2 and the drone 2.

Let T be the precise moment of the designation of a target object in an image received by the remote station 4, and that all the images received by the remote station 4 are previously time-stamped, and each of these images is identified by a unique identifier.

FIG. 2 illustrates the processing of the images made in the remote station 4. These processes include the following steps:
extracting (step 10) the characteristic points in the images by one or more sensors;
tracking (step 12) the said characteristic points from one image to another;
calculating (step 14) the transient homography between two images, whether or not successive, on the basis of compared points;
readjusting (step 16) by means of the said transient homography an image in the reference system of the previous image, and
determining (step 18) which points or which pixels are moving in the reference system of the observed scene;
grouping (step 20) the moving points into objects using geometrical criteria such as the relative distances and the appropriateness of the movement;
estimating (step 22) the positions and the speed vectors in the image of the objects according to the positions in one or more previous images.

In a particular embodiment of the invention and average number of points to be tracked is determined in each image, which depends globally on the number of pixels. Typically, the Harris or Plessey points will be considered, or again more complex descriptors such as the SIFTs or the SURFS). The tracking may be accomplished by a KLT (Kanade-Lucas-Tomasi) type method, or by a Kalman filter associated with each of the points, or more simply by readjustment of the cloud of points via a Hough transform, for example, and new points are added as soon as new image parts appear, or as soon as tracked points leave the image. The new points are calculated by the previously described method, typically the Harris method, in the zones of the image where tracked points are least dense.

In cases in which the 3D disparities would be too visible, notably in the case of very low altitude flying, the calculation of the homography is replaced by the calculation of the fundamental matrix or of the essential matrix, by a RANSAC-type approach, in order to be faithful to the projective structure of the observed scene.

A target designation at instant T leads to a selection of a point in the image.

If the designation point is on a moving object the designation will equate to the selection of the object; otherwise it will be a “background” point, the speed vector of which equates to the translational motion vector of the background.

In a particular embodiment of the method according to the invention the system automatically selects the moving object closest to the designation of the operator 8.

In another embodiment of the invention the designation is accomplished by an automatic target detection/recognition algorithm. The command is then sent to the drone 2 in the form of a structure including an image position, a speed vector, a nature (fixed or mobile target) and the time-stamp (instant T-L of acquisition of the image processed by the remote station at instant T).

FIG. 3 illustrates the processing undertaken in the drone 2.

These processes include the following steps:
extracting (step 30) characteristic points in the images by one or more sensors,
tracking (step 32) the said characteristic points by the same method as the one used in the remote station 4,
determining (step 34) transient homographies from one image to the next by the same method as the one used in the remote station 4,
determining (step 36) moving objects, and
estimating (step 38) the positions and the speed vectors of the said objects at each image by the same method as the one used in the remote station

When a designation command arrives at instant T+L and makes reference to the state vector representing the position and the speed vectors of a target object in the image acquired at T-L, a prediction of the movement in 2 L seconds is made using this transmitted state vector. Note that this vector is known due to the time-stamp sent with the images from the drone 2 to the remote station 4.

If this is a fixed target the predicted point is considered as a target, and if it is a mobile target, the mobile object most compliant with the prediction, both in terms of position and of speed vector, is chosen as the target. If the prediction leaves the frame of the image the position is nevertheless taken into account. It will enable the target to be brought back into the camera's field of view by modifying the axis of sight of the said camera. In a particular embodiment the prediction is made using a Kalman filter. It should be noted that this prediction can be made, as desired, on board or on the ground.

Thus, since the object designated at instant T in the image T-L is now found in the image T+L, it is then possible to track the object. The predetermined actions can then be applied, such as for examples centring of the axis of sight on the designated target.

FIG. 4 illustrates diagrammatically the steps of a particular embodiment of the invention.

According to this embodiment the method includes the following steps:
extracting (step 40) characteristic points in the images by one or more sensors,
tracking (step 42) the said characteristic points by the same method as the one used in the remote station 4,
determining (step 44) transient homographies from one image to the next by the same method as the one used in the remote station 4,
determining (step 46) moving objects, and,
estimating (step 48) the positions and the speed vectors of the said objects at each image by the same method as the one used in the remote station 4,
recording (step 50) for all the images over (at minimum) the final 2L seconds all the compared points, the homographies and the moving objects (position and speed vector at each instant).

When a designation command arrives at instant T+L at the drone 2, and makes reference to the state vector (position and speeds) of a target in the image acquired at T-L; the history recorded at instant T-L is then consulted to find the designated object.

If this is a moving object it will appear in the list of recorded moving objects. The most reliable one will be selected. The history of the tracking of this point is then used to find directly its position in the current image.

If the point leaves, temporarily or not, the frame of the image its position is predicted using the transient homographies, the speed vector at the time of the last observation and the readjustment of this speed vector in the reference systems of the following images.

If this is a “background” object it is designated by its position in image T-L. Its position in the following images is then calculated by application of the transient homographies between successive images. The position thus obtained in each image may be validated by correlation, for example by using KLT-type tracking.

The prediction may continue even when the object leaves, whether or not temporarily, the camera's field of view.

In the case of a object which is fixed at instant T-L but mobile at instant T+L, both the previous techniques are used, respectively from instant t to T+L and from instant T-L to instant t, where instant t is the moment when the object began to move.
tracking of the designated object found in image T+L.

This case includes an estimated position outside the frame of the current image.
application of the predetermined actions (for example, centring of the camera on the object).

1. A method for controlling, from a remote station, a camera on board a mobile station transmitting to the remote station images including at least one target object to be located in a zone explored by the camera, the method comprising:
estimating, with the remote station, a period of latency L between the despatch of a command from the mobile station and the execution of the said command by the mobile station;
transmitting, with the mobile station, a first image acquired by the camera at an instant T-L to the remote station,;
transmitting, with the remote station, a position of the target object in the said-first image to the mobile station; and
comparing, with the mobile station, the position of the target object in the first image with the position of the target object in at least a second image acquired after the first image, wherein if the compared positions are identical in the two images realigned in relation to one another the mobile station transmits the position to the remote station for validation,
and wherein if the compared positions are not identical in the two images, the mobile station determines, in real time, independently, a predicted trajectory of the target object in the second image, and controls the on-board camera in real time in order to track the target object over the predicted trajectory.

2. A method according to claim 1, in which the trajectory of the target object in the second image is determined by a predictive computation according to a position and movement vector of the target object at an instant T-L.

3. A method according to claim 2, characterised in that it also includes the further comprising:
in the remote station:
realigning the first image and the second image;
determining the position and speed vector of all objects moving in the scene observed by the camera;
determining the position and speed vector of the target object in the first image, either among the moving objects, or among background elements;
calculating a prediction of the position and speed of the target object at instant T+L;
transmitting a designated position, the predicted position and the predicted speed vector of the target object to the mobile station.

4. A method according to claim 3, further comprising readjustment of the first image and of the second image by estimation of the a transient homography.

5. A method according to claim 4, further comprising recording the transient homographies, image by image, and an overall position of the mobile objects from instant T-L to instant T+L in the mobile station.

6. A method according to claim 1, in which the latency time L is estimated by time-stamping of data and by synchronization of the said-remote and mobile stations.

7. A method according to claim 1, in which the target object is fixed or mobile.

8. A method according to claim 7, in which if the target object is mobile and if its trajectory leaves the field of view of the camera's field of view at an instant t between T-L and T+L, the position of the said-target object is estimated in the mobile station by a predictive calculation according to its position and its speed vector at instant t.

9. A method according to claim 1, in which the camera is on board a drone.

10. A method according to claim 1, in which the target object is an individual, a vehicle, or an aircraft.

11. A device for controlling, from a remote station, a camera on board a mobile station transmitting to the remote station images including at least one target object to be located in a zone explored by the camera, the device comprising:
means for estimating the period of latency L between the despatch of a command from the mobile station, and the execution of the command by the said mobile station;
wherein the mobile station comprises:
means for comparing a position of the target object in a first image acquired by the camera at an instant T-L with the position of the object in at least a second image acquired after the first image,
means for predictive calculation, wherein the means for predictive calculation is configured to determine, in real time, a predicted trajectory of the target object in the second image,
means for controlling, in real time, the on-board camera to the target object in the predicted trajectory.

12. A computer program product recorded on a non-transitory recording medium and including instructions to control, when it is executed on a computer, a camera on board a mobile station from a remote station, where the mobile station transmits to the remote station images including at least one target object to be located in a zone explored by the camera,
the computer program product comprising:
a first executable module in the remote station comprising:
computer-readable instructions causing the first executable module to estimate the period of latency L between the despatch of a command from the mobile station and the execution of the command by the mobile station,
computer-readable instructions causing the first executable module to determine the movement from one image to another of the fixed objects and of the mobile objects in order to facilitate the designation of the target object,
a second executable module in the mobile station including:
computer-readable instructions causing the second executable module to compare a position of the target object in a first image acquired by the camera at an instant T-L with the position of the object in at least a second image acquired after the first image,
computer-readable instructions causing the second executable module to determine in real time a predicted trajectory of the target object in the second image, and
computer-readable instructions causing the second executable module to control, in real time, the on-board camera to track the target object in the predicted trajectory.

13. A method according to claim 2, in which the camera is on board a drone.

14. A method according to claim 3, in which the camera is on board a drone.

15. A method according to claim 4, in which the camera is on board a drone.

16. A method according to claim 5, in which the camera is on board a drone.

17. A method according to claim 6, in which the camera is on board a drone.

18. A method according to claim 7, in which the camera is on board a drone.

19. A method according to claim 8, in which the camera is on board a drone.
